(19) United States
(12) Patent Application Publication
(10) Pub. No.: US 2024/0193418 A1
(43) Pub. Date: Jun. 13, 2024

(54) EFFICIENT MACHINE LEARNING TRAINING ON SPREADSHEET DATA

(71) Applicant: Google LLC, Mountain View, CA (US)

(72) Inventors: Mathieu Claude Charles-Marie Guillame-Bert, Bonstetten (CH); Jan Pfeifer, Thalwil (CH)

(21) Appl. No.: 18/533,036

(22) Filed: Dec. 7, 2023

Related U.S. Application Data
(60) Provisional application No. 63/430,995, filed on Dec. 7, 2022.

(51) Int. Cl. G06N 3/08; G06F 40/18

(52) U.S. Cl. CPC G06N 3/08; G06F 40/18

(57) ABSTRACT

Methods, systems, and apparatus, including computer programs encoded on computer storage media, for generating and displaying outputs conditioned on inputs. One of the methods includes displaying an interactive spreadsheet on a display of a user device; receiving an input from a user that identifies one or more cells to be filled in with respective predicted values; in response to receiving the input: training a machine learning model on the values in the cells of the interactive spreadsheet to predict respective values for the one or more identified cells; generating a respective predicted value for each of the identified cells using the trained machine learning model; and displaying the respective predicted values on the user device.

### CROSS-REFERENCE TO RELATED APPLICATION

This application claims priority to U.S. Provisional Application No. 63/430,995, filed on Dec. 7, 2022. The disclosure of the prior application is considered part of and is incorporated by reference in the disclosure of this application.

### BACKGROUND

This specification relates to generating and displaying outputs conditioned on inputs using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of operations to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that generates and displays an output conditioned on inputs.

According to a first aspect there is provided a computer-implemented method comprising: displaying an interactive spreadsheet on a display of a user device, wherein the interactive spreadsheet displays values in cells arranged by row and column; receiving an input from a user that identifies one or more cells to be filled in with respective predicted values; in response to receiving the input: training a machine learning model on the values in the cells of the interactive spreadsheet to predict respective values for the one or more identified cells; generating a respective predicted value for each of the identified cells using the trained machine learning model; and displaying the respective predicted values on the user device.

In some implementations, each respective predicted value is displayed in a respective previously empty cell on the interactive spreadsheet.

In some implementations, the respective predicted values are displayed on the interactive spreadsheet without transitioning to an intermediate display.

In some implementations, training the machine learning model, generating a respective predicted value for each of the identified cells using the trained machine learning model, and displaying the respective predicted values are performed on the user device.

In some implementations, training the machine learning model, generating a respective predicted value for each of the identified cells using the trained machine learning model, and displaying the respective predicted values are performed without receiving any additional user inputs.

In some implementations, training the machine learning model comprises training the machine learning model on the user device without transferring the values in the interactive spreadsheet to other computers.

In some implementations, the method includes determining whether to perform training of the machine learning model on the user device or on a remote server, and further comprises performing training of the machine learning model on the user device or on the remote server in dependence on the determination. For example, the method may comprise receiving an input from a user, wherein the input indicates whether training should be performed on the user device or on the remote server. Alternatively, the system may determine whether to perform training on the user device or on the remote server in dependence on the type of machine learning model to be trained.

In some implementations, training the machine learning model comprises determining which cells in the interactive spreadsheet are provided as input features and target outputs for the training of the machine learning model based on the identified cells.

In some implementations, training the machine learning model comprises preprocessing the values in the cells using metadata for the corresponding cells.

In some implementations, the method further comprises: receiving an input from the user that identifies a machine learning model to be refined; in response to receiving the input: transmitting data representing the values in the cells of the interactive spreadsheet and data representing the machine learning model to a remote server; generating a refined machine learning model based on the machine learning model; and receiving data representing the refined machine learning model from the remote server.

In some implementations, the method further comprises: receiving an input from the user that identifies one or more cells to be filled in with respective predicted values; in response to receiving the input: transmitting data representing the values in the cells of the interactive spreadsheet to a remote server; training a machine learning model on the values in the cells of the interactive spreadsheet to predict respective values for the one or more identified cells; receiving data representing the trained machine learning model from the remote server; generating a respective predicted value for each of the identified cells using the trained machine learning model; and displaying the respective predicted values on the user device.

In some implementations, the method further comprises: receiving an input from the user that identifies one or more cells to be filled in with respective predicted values; in response to receiving the input: transmitting data representing the values in the cells of the interactive spreadsheet to a remote server; training a machine learning model on the values in the cells of the interactive spreadsheet to predict respective values for the one or more identified cells; generating a respective predicted value for each of the identified cells using the trained machine learning model; receiving data representing the respective predicted values from the remote server; and displaying the respective predicted values on the user device.

In some implementations, the method further comprises: receiving an input from the user that identifies one or more cells to be filled in with respective predicted values; in response to receiving the input: training a machine learning model on the values in the cells of the interactive spreadsheet to predict respective values for the one or more identified cells; transmitting data representing the values in the cells of the interactive spreadsheet and data representing the trained machine learning model to a remote server; generating a respective predicted value on the remote server for each of the identified cells using the trained machine learning model; receiving data representing the respective predicted values from the remote server; and displaying the respective predicted values on the user device.

In some implementations, the method further comprises: receiving an input with one or more additional values in cells in the interactive spreadsheet; in response to receiving the input: determining which cells corresponding to the one or more additional values the trained machine learning model is trained to predict; generating a respective predicted value for each cell corresponding to the one or more additional values the trained machine learning model is trained to predict using the trained machine learning model; and displaying the respective predicted values on the user device.

In some implementations, the method further comprises: receiving an input from the user that identifies a trained machine learning model to be used in another interactive spreadsheet or shared with another user; in response to receiving the input, saving data representing the trained machine learning model to a remote server or the user device; and displaying the location of the saved data representing the trained machine learning model.

In some implementations, the method further comprises: receiving an input from the user that identifies a trained machine learning model to be evaluated; and in response to receiving the input, performing an evaluation of the trained machine learning model and displaying performance metrics from the evaluation on the user device.

In some implementations, the method further comprises: receiving an input from the user that identifies a trained machine learning model to be analyzed; and in response to receiving the input, performing calculations of relative importance of input features on predicted outputs of the trained machine learning model and displaying results from the calculations on the user device.

In some implementations, the method further comprises: receiving an input from the user that identifies a trained machine learning model to be used for prediction; in response to receiving the input: determining which cells in the interactive spreadsheet the trained machine learning model is trained to predict; generating a respective predicted value for each cell in the spreadsheet the trained machine learning model is trained to predict using the trained machine learning model; and displaying the respective predicted values on the user device.

According to a second aspect there is provided a method comprising: displaying an interactive spreadsheet on a display of a user device, wherein the interactive spreadsheet displays values in cells arranged by row and column; receiving an input from the user that identifies cells with existing values in the spreadsheet to be validated; in response to the input: dividing the cells into two or more subsets comprising input features and corresponding target outputs to the cells to be validated; for each subset, training a machine learning model on the values in the cells in the other subsets to predict values for the cells to be validated; for each subset, generating a predicted value for each cell to be validated using the machine learning model that was trained for the subset; and displaying an indication of which cells to be validated have existing values which are likely to be abnormal on the user device.

In some implementations, the method further comprises: determining an accuracy for each machine learning model; determining scores for the cells to be validated based on a difference between each predicted value and the existing value for the cell and the accuracy for the machine learning model that generated the predicted value; and displaying an indication of which cells to be validated have existing values which are likely to be abnormal based on the scores on the user device.

According to a third aspect there is provided a method comprising: displaying, in a first portion of a user interface in a display of a user device, an interactive spreadsheet, wherein the interactive spreadsheet displays values in cells arranged by row and column; while the interactive spreadsheet is displayed in the first portion, displaying, in a second portion of the user interface, a first user interface element, wherein the first user interface element includes: a second user interface element that allows a user to identify one or more cells in the interactive spreadsheet and a first user interface control that, when selected, causes the interactive spreadsheet to be updated with respective predicted values for each of the one or more cells identified through the second user interface element; receiving a user input to the first user interface control; and in response to receiving the input: updating the interactive spreadsheet to display the predicted values.

In some implementations, the first user interface element is displayed in response to a user input to a menu item of the interactive spreadsheet while the interactive spreadsheet is displayed.

In some implementations, the predicted values for each of the one or more cells identified through the second user interface element are predicted by a trained machine learning model.

In some implementations, the first user interface element includes a third user interface element that allows a user to select a task out of a plurality of tasks to be performed in the interactive spreadsheet.

In some implementations, one of the tasks is identifying abnormal values in cells that have existing values in the interactive spreadsheet, and wherein, when the task selected by the user is identifying abnormal values, the second user interface element is updated to allow a user to identify one or more cells in the interactive spreadsheet to be validated.

In some implementations, when the task selected by the user is identifying abnormal values, the first user interface element includes a second user interface control that, when selected, causes the interactive spreadsheet to be updated with an indication of which cells have existing values which are likely to be abnormal for each of the one or more cells identified through the second user interface element, and the method further comprises: receiving a user input to the second user interface control; and in response to receiving the input: updating the interactive spreadsheet to display the indication of which cells have existing values which are likely to be abnormal.

In some implementations, one of the tasks is refining a trained machine learning model, and wherein, when the task selected by the user is refining a trained machine learning model, the second user interface element is updated to allow a user to identify one or more machine learning models to be refined.

In some implementations, when the task selected by the user is refining a trained machine learning model, the first user interface element includes a third user interface control that, when selected, causes the interactive spreadsheet to be updated with an indication of how the trained machine learning model was refined, and the method further comprises: receiving a user input to the third user interface control; and in response to receiving the input: updating the interactive spreadsheet to display the indication of how the trained machine learning model was refined.

In some implementations, one of the tasks is using a trained machine learning model in another interactive spreadsheet or sharing a trained machine learning model with another user, and wherein, when the task selected by the user is using a trained machine learning model in another interactive spreadsheet or sharing a trained machine learning model with another user, the second user interface element is updated to allow a user to identify one or more machine learning models to be used or shared.

In some implementations, when the task selected by the user is using a trained machine learning model in another interactive spreadsheet or sharing a trained machine learning model with another user, the first user interface element includes a fourth user interface control that, when selected, causes the interactive spreadsheet to be updated with a location of saved data representing the trained machine learning model, and the method further comprises: receiving a user input to the fourth user interface control; and in response to receiving the input: updating the interactive spreadsheet to display the location of the saved data representing the trained machine learning model.

In some implementations, one of the tasks is evaluating a trained machine learning model, and wherein, when the task selected by the user is evaluating a trained machine learning model, the second user interface element is updated to allow a user to identify one or more machine learning models to be evaluated.

In some implementations, when the task selected by the user is evaluating a trained machine learning model, the first user interface element includes a fifth user interface control that, when selected, causes the interactive spreadsheet to be updated with performance metrics from an evaluation of the trained machine learning model, and the method further comprises: receiving a user input to the fifth user interface control; and in response to receiving the input: updating the interactive spreadsheet to display performance metrics from the evaluation of the trained machine learning model.

In some implementations, one of the tasks is analyzing a trained machine learning model, and wherein, when the task selected by the user is analyzing a trained machine learning model, the second user interface element is updated to allow a user to identify one or more machine learning models to be analyzed.

In some implementations, when the task selected by the user is analyzing a trained machine learning model, the first user interface element includes a sixth user interface control that, when selected, causes the interactive spreadsheet to be updated with results from calculations of relative importance of input features on predicted outputs of the trained machine learning model, and the method further comprises: receiving a user input to the sixth user interface control; and in response to receiving the input: updating the interactive spreadsheet to display results from the calculations of relative importance of input features on predicted outputs of the trained machine learning model.

In some implementations, one of the tasks is using a trained machine learning model for prediction, and wherein, when the task selected by the user is using a trained machine learning model for prediction, the second user interface element is updated to allow a user to identify one or more machine learning models to be used for prediction.

In some implementations, when the task selected by the user is using a trained machine learning model for prediction, the first user interface element includes a seventh user interface control that, when selected, causes the interactive spreadsheet to be updated with respective predicted values for each of the one or more cells in the interactive spreadsheet the trained machine learning model is trained to predict; receiving a user input to the seventh user interface control; and in response to receiving the input: updating the interactive spreadsheet to display the predicted values.

According to another aspect, a system comprises one or more computers and one or more storage devices storing instructions that when executed by the one or more computers cause the one or more computers to perform the operations of any method described herein.

According to another aspect, one or more non-transitory computer-readable storage media store instructions that when executed by one or more computers cause the one or more computers to perform the operations of any method described herein.

Particular embodiments of the subject matter described in this specification can be implemented so as to realize one or more of the following advantages.

Conventional techniques for generating and displaying outputs conditioned on inputs using machine learning models have limitations which make them difficult or impractical for some users to use. For example, even if a user's dataset is available in a spreadsheet, some techniques require the user to understand machine learning concepts and terms to select training data and training options. Some techniques may require the user to transition through many screens and separate displays to sufficiently specify a training scheme and receive outputs from a machine learning model. Other techniques require the user to write and deploy code to extract data in the spreadsheet and to train a model on the data. In addition, some techniques require machine learning models to be trained on a remote server, increasing the amount of time the user spends waiting for data to be transferred to and from the remote server, and adversely affecting the user experience.

The system allows a user to train and use machine learning models without having to understand the technical concepts of machine learning, and without having to write or deploy code. For example, the system can display an interactive spreadsheet on a user device. The interactive spreadsheet displays values in cells arranged by row and column. A user can identify cells they want to predict a value for, and the system can train a machine learning model, generate predicted values, and display predicted values without any further inputs from the user. The user does not need to have knowledge of or have to select training, testing, and/or validation data, and does not need to have knowledge of or have to pick a type of machine learning model to be trained. The user also does not have to select which cells should be input features or target outputs for the training of the machine learning model. The user can also identify cells they want to validate, and the system can perform cross-validation, train machine learning models, and generate predicted values without any further inputs from the user. Furthermore, after a machine learning model has been trained, the system also allows a user to save and share the machine learning model, use the machine learning model for prediction, evaluate the machine learning model, and analyze the machine learning model without having to understand the technical concepts or terms of machine learning.

The system provides for a convenient user experience. The system does not require a user to download and install special programs. For example, the system can run on a web browser on a user device.

Some conventional techniques require machine learning models to be trained on a remote server, which requires that a user's dataset be sent over a network to the remote server, increasing the risk of data security and data privacy issues, and the use of network bandwidth.

The system provides for more data security and data privacy than machine learning training systems that perform training on a remote server. For example, the system can train a machine learning model on the values in the cells of the interactive spreadsheet on a user device. The system does not have to send the values in the cells of the interactive spreadsheet to a remote server for training, which may expose the values in the cells to the risk of leakage or interception by a third-party.

The system reduces network bandwidth compared to machine learning training systems that perform training on a remote server. For example, the system can train a machine learning model on the values in the cells of the interactive spreadsheet on a user device. The system does not have to send the values in the cells of the interactive spreadsheet to a remote server for training over a network, which can use large amounts of network resources, especially for large amounts of information that are typically used to train machine learning models.

Some conventional techniques do not allow users to re-use a trained machine learning model, which can lead to inefficient use of computing resources if a user later decides to make the same type of prediction on new data.

The system can save computing resources. For example, after a machine learning model has been trained, the system can save data representing the machine learning model to the user device or to a remote server for later use by the user or another user. Also, a system that trains a machine learning model on the user device saves resources such as electricity and computing power for a remote server that would typically run such training.

Some conventional techniques display predicted values in separate displays than the display the user entered their data on, or require users to enter data in a specific display or manner. Others do not allow users to choose where to train a machine learning model, or allow integration with different applications or programs.

The system provides for an intuitive and interactive user experience. For example, the system can display predicted values on the interactive spreadsheet without transitioning to an intermediate display. Each predicted value can be displayed directly on the interactive spreadsheet. For example, if a user identifies a cell to be filled in with a predicted value, the system can predict the value for the cell and display the value next to or directly in the cell. The user can thus easily identify and make use of the predicted values in the context of the interactive spreadsheet the user is already working with. In addition, the system can train the machine learning model, generate predicted values, and display the predicted values on the user device, reducing the amount of data that is sent to a remote server, and reducing the amount of time spent waiting for data to be sent to and received from a remote server.

The system also provides for a flexible user experience. For example, a user can choose to train a machine learning model on a remote server and/or choose to generate predictions on a remote server, for example if the user has a large amount of data in the interactive spreadsheet. A user can also choose to refine their machine learning model on a remote server.

The system can integrate with other applications or programs to generate predictions without user input. For example, in an interactive spreadsheet where a machine learning model has already been trained, if the system receives new data from an integrated application or program to the interactive spreadsheet, the system can generate a prediction for the new data without any further user input.

Some conventional techniques may not perform preprocessing of input features which can lead to a less accurate trained machine learning model. Others may require a user to designate the format of input features or to format input features themselves, which can lead to user errors in the formatting of the input features and a less accurate trained machine learning model.

The system can use metadata provided in the interactive spreadsheet to perform preprocessing of input features, which can lead to a more accurate trained machine learning model than if a machine learning model were trained without performing preprocessing of input features. For example, each cell can be associated with metadata that identifies the type of data of the value in the cell. The system can preprocess the value in the cell using the metadata for the cell to format the value for an input feature, or to extract input features from the value.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for displaying predicted values on a user device.

FIG. 2 is a flow diagram of an example process for displaying predicted values on a user device.

FIG. 3 is a flow diagram of an example process for displaying predicted abnormal values on a user device.

FIG. 4A shows an example display of an interactive spreadsheet.

FIG. 4B shows an example display of predicted values on an interactive spreadsheet.

Like reference numbers and designations in the various drawings indicate like elements.

### DETAILED DESCRIPTION

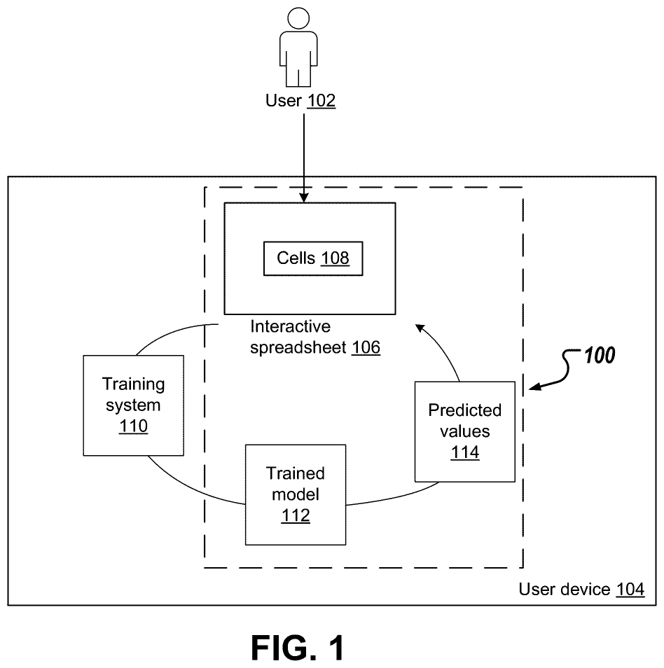

FIG. 1 is a diagram of an example system 100 for displaying predicted values on a user device 104. The system 100 runs on the user device 104, e.g., as part of a spreadsheet program, as an add-on to the spreadsheet program, or as one or more separate computer programs running on the user device 104.

The user device 104 can be any type of computer or computing device that has a display and is configured to receive an input from a user 102. For example, the user device 104 can be a computer, laptop, tablet, or mobile phone that has a display and can receive user inputs through interfaces such as a keyboard, mouse, touchpad, or touchscreen.

The user device 104 is configured to display an interactive spreadsheet 106. More specifically, a spreadsheet program that executes at least partially on the user device 104 can cause the user device 104 to display the interactive spreadsheet 106 in a user interface of the user device 104.

The interactive spreadsheet 106 can display values in cells arranged by row and column. The values can represent various types of data, for example, text, numbers, dates, times, Boolean values, or currency. Each cell can be associated with metadata that can identify, for example, the type of data of the value in the cell.

The spreadsheet program can process user inputs to the user device 104 in order to update the interactive spreadsheet 106 while the interactive spreadsheet 106 is displayed in the user interface. The spreadsheet program can be any appropriate software program running on the mobile device that allows users to create, edit, and save interactive spreadsheets. For example, the spreadsheet program can be a mobile application, a desktop application, or a web application. A web application can include client-side scripts that run on the web browser to receive user interactions and send requests to a remote server, and server-side scripts that run on a remote server to receive and respond to requests from the web browser. The web browser and remote server can communicate over a network. The web application can run in a window or a tab of a web browser of a user device and allow users to create and modify interactive spreadsheets in the web browser. The web application can save interactive spreadsheets to the user device or to a remote server.

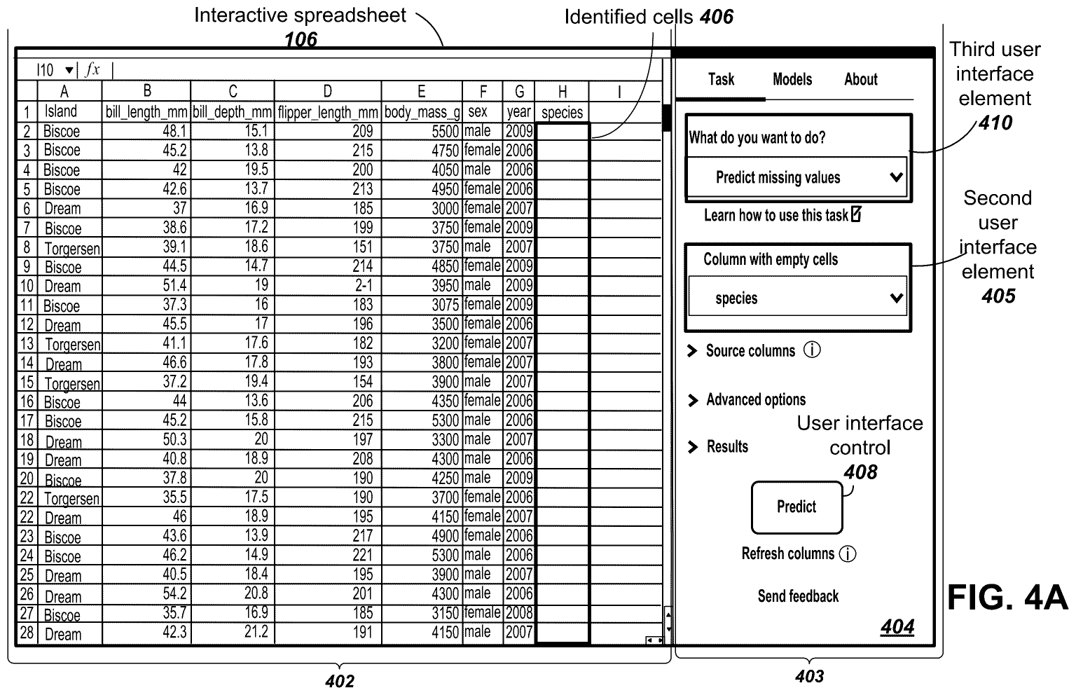

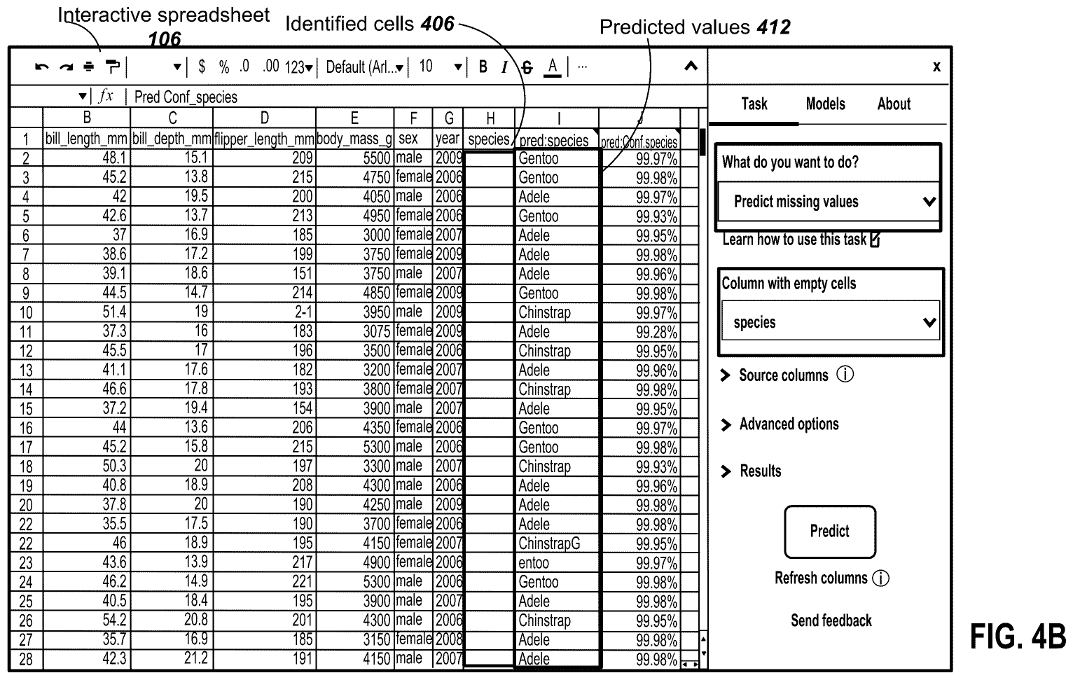

As part of the functionality of the spreadsheet program and while the interactive spreadsheet 106 is being presented to the user, the system 100 can receive a user input from the user 102 on the user device 104 that identifies one or more cells 108 in the interactive spreadsheet 106 to be filled in with predicted values. For example, some of the cells in the interactive spreadsheet 106 may not have a value, and a user may desire that appropriate values for the cells 108 be predicted given the values in the other cells in the interactive spreadsheet 106. An example of a user input that identifies one or more cells 108 is described in further detail below with reference to FIG. 4A.

The system 100 can use a training system 110 to train a machine learning model on the values in the cells of the interactive spreadsheet 106 to predict values for the one or more identified cells 108, resulting in a trained model 112. Based on the identified cells 108, the system 100 can determine which cells in the interactive spreadsheet 106 contain values to provide to the training system 110 as input features, and which cells contain values to provide to the training system 110 as target outputs. The training system 110 can pick the type of machine learning model to be trained, e.g., pick a predefined or default type of machine learning model, or analyze the input features and the target outputs to identify a type of machine learning model. For example, types of machine learning models can include a gradient boosted trees model, a generalized linear model, a support vector machine, a decision tree model, or a neural network model, e.g., a multilayer perceptron (MLP). The machine learning models can be trained using machine learning training algorithms such as minimizing an error, computing a gradient, or performing backpropagation.

As an example, the input features may include dates, and the target outputs may include the values that represent traffic on those dates. The training system 110 can pick a type of machine learning model to be trained that can predict values for the one or more identified cells 108, e.g., values that represent traffic for future dates.

In some implementations, the system 100 can use the metadata associated with cells in the interactive spreadsheet 106 to preprocess the values in the cells to provide to the training system 110. For example, a date that has a day, month, and year can be represented as a sequence of numbers. A value that the user 102 intends to represent a date can be interpreted by the training system 110 as a number, a string of text, or as a date. By using metadata that identifies the type of data for the values, the system 100 can preprocess the values so that the training system 110 can more accurately interpret the values. In other words, the system 100 can map the raw values in the cell into encoded representations that can be provided as input features for the training of the machine learning model. For example, the system can convert each value that is a date into a format that can be provided to the training system 110 as input features that the training system 110 can interpret, such as a day, month, year, and/or time elapsed from a certain point in time, e.g., a Unix timestamp.

The training system 110 is shown in FIG. 1 as running on the user device 104. But, as described, in some implementations, the training system 110 instead executes on a remote server or other computer(s) remote from the user device 104. The trained model is also shown in FIG. 1 as running on the user device 104. But, as described, in some implementations, the trained model can run on a remote server or other computer(s) remote from the user device 104. In some examples, an input may be received from a user which indicates whether training should be performed on the user device or on a remote server. For example, a user may interact with a user interface displayed on the user device to select whether training should be performed on the user device or on the remote server. Alternatively, the system may determine whether to perform training on the user device or on the remote server in dependence on the type of machine learning model to be trained.

The system 100 can use the trained model 112 to generate a predicted value 114 for each of the identified cells 108.

The system 100 can display the predicted values 114 to the user 102 through the user device 104. For example, the system 100 can display the predicted values in previously empty cells on the interactive spreadsheet 106, or in the corresponding identified cells on the interactive spreadsheet 106. An example of displaying the predicted values 114 is described in further detail below with reference to FIG. 4B. The predicted values 114 can be displayed on the interactive spreadsheet 106 without transitioning to an intermediate display.

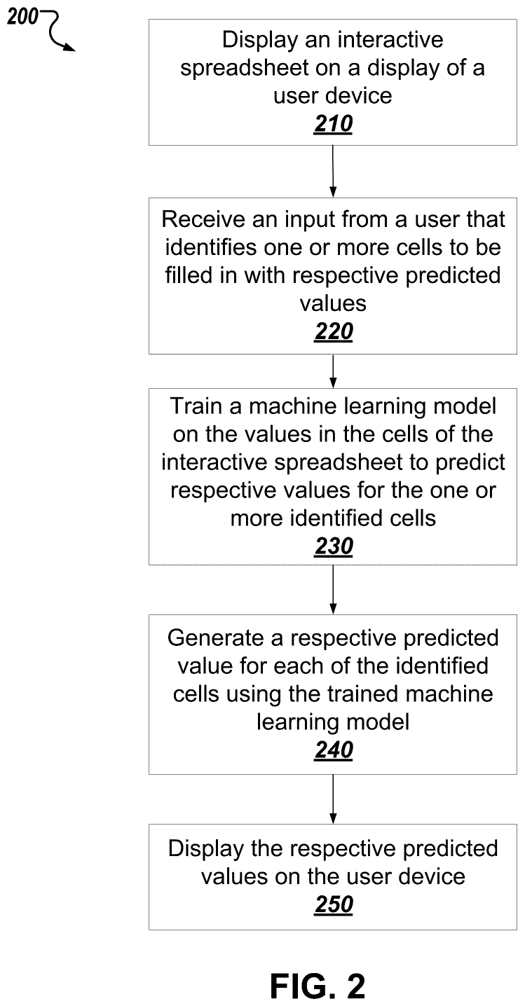

FIG. 2 is a flow diagram of an example process 200 for displaying predicted values on a user device. The process 200 can be performed by any appropriate system, e.g., the system 100 described above with reference to FIG. 1.

The system displays an interactive spreadsheet on a display of a user device (step 210). The interactive spreadsheet can display values in cells arranged by row and column. The system can display and process user inputs to the interactive spreadsheet through a spreadsheet program.

The system receives an input from a user that identifies one or more cells to be filled in with respective predicted values (step 220).

The system trains a machine learning model on the values in the cells of the interactive spreadsheet to predict respective values for the one or more identified cells (step 230). In some implementations, the system trains the machine learning model on the user device. Training the machine learning model can include training the machine learning model on the user device without transferring the values in the interactive spreadsheet to any other computers. That is, the system can use a training system that is one or more computer programs executing on the user device. The system can divide the values in the cells of the interactive spreadsheet into training, testing, and/or validating data and provide the training, testing, and/or validating data to the training system. The training system can run a machine learning training algorithm on training data extracted from the values in the cells of the interactive spreadsheet on the user device, resulting in a trained machine learning model.

In some implementations, the training system executes on the user device as described above. In other implementations, the training system runs on one or more remote computers, such as a remote server.

As described below, the system can use the trained machine learning model to generate a respective predicted value for each of the identified cells on the user device. Alternatively, the system can instead generate a respective predicted value for each of the identified cells on a remote server.

Training the machine learning model can include determining which cells in the interactive spreadsheet are provided as input features and target outputs for the training of the machine learning model based on the identified cells. For example, the system can determine which cells in the interactive spreadsheet are provided to a training algorithm as input features and target outputs.

For example, a user can input values to the interactive spreadsheet so that each row represents a data point, and each cell corresponding to an intersecting column in the row corresponds to an attribute of that data point. For example, as shown in FIG. 4A below, row “2” represents a penguin, and the value in the cell at row 2 and column B is the bill length in millimeters (“bill_length_mm”) of the penguin. The user can identify cells in column “H,” for example, as cells to be filled with predicted values. Some cells for some rows in column “H” may have values, and other cells in column “H” may not. For example, the user can identify cells in column “H” that do not have values as the cells to be filled with predicted values.

The system generates, for each row that has a value in the cell in the column with identified cells, a respective training example that includes (i) the values in the row other than the one in the column with identified cells as input features and (ii) the value in the row in the column with identified cells as the target output for the input features. In the example interactive spreadsheet described in FIG. 4A below, the system can generate, for each row that has a value in the cell in column “H,” a respective training example that includes (i) the values in the row in columns “B” through “G” as input features and (ii) the value in the row in column “H” as the target output for the input features. The system provides the training examples to the training system to run a machine learning algorithm to generate a trained machine learning model.

As another example, a user can input values to the interactive spreadsheet so that each column represents a data point, and each cell corresponding to an intersecting row in the column corresponds to an attribute of that data point. The user can identify cells in row “R,” for example, as cells to be filled with predicted values. Some cells for some columns in row “R” may have values, and other cells in row “R” may not. For example, the user can identify cells in row “R” that do not have values as the cells to be filled with predicted values.

The system generates, for each column that has a value in the cell in the row with identified cells, a respective training example that includes (i) the values in the column other than the one in the row with identified cells as input features and (ii) the value in the column in the row with identified cells as the target output for the input features. For example, if the user identifies cells in row “R” as cells to be filled with predicted values, the system can generate, for each column that has a value in the cell in row “R,” a respective training example that includes (i) the values in the column in rows “B” through “Q” as input features and (ii) the value in the column in row “R” as the target output for the input features. The system provides the training examples to the training system to run a machine learning algorithm to generate a trained machine learning model.

In some implementations, training the machine learning model can include preprocessing the values in the cells using metadata for the corresponding cells. For example, the system can use metadata that identifies the type of data of the value in a cell to format and interpret the values before training a model on the values. As an illustrative example, the interactive spreadsheet can have a column with cells that contain values that represent dates. The dates can be in the format of “ddmmyyyy” which can be interpreted as a numeric value or a string of text. However, this numeric value or string of text may not provide the information that a date represents to the machine learning model. For example, a date is cyclical and represents time, whereas a numeric value or string of text that is “ddmmyyyy” may not necessarily capture the cyclical nature of a date. Thus if the system can use the metadata associated with the cells in the column to identify that the values in the cells are a date, the system can interpret the values before providing the values as input features. For example, the system can convert a date into a numeric value that represents time elapsed from a certain point in time, such as a Unix timestamp. The system can also extract one or more input features from the date, for example, day, month, year, day of the year, day of the month, day of the week, etc. The system can preprocess the values in the cells using metadata for the corresponding cells to format and interpret the values to be used as input features.

As another example, the system can use the metadata for a given cell to translate a string, e.g., a text string or other alphanumeric string, into an encoded representation that can be provided as an input feature for the training of the model. For example, the system can identify, based on the metadata, that the string is one of a fixed set of categorical features and then map the string to a one-hot encoding of the categorical feature or a real-valued embedding of the categorical feature.

The system generates a respective predicted value for each of the identified cells using the trained machine learning model (step 240). For example, as described above, a user can input values to the interactive spreadsheet so that each row represents a data point, and each cell corresponding to an intersecting column in the row corresponds to an attribute of that data point. The user can identify cells to be filled with predicted values. The system generates, for each row that has an identified cell, a model input that includes the values in the row other than the one in the column with identified cells. The system provides the model inputs to the trained machine learning model to generate predicted values for the identified cells.

For example, in some implementations where the values in one of the columns represent dates, and the identified cells include cells in one or more other columns, the system can generate, for each row that has an identified cell, a model input that includes the values in the row other than the ones in the columns with identified cells. The system provides the model inputs to the trained machine learning model to generate predicted values for the identified cells.

As another example, a user can input values to the interactive spreadsheet so that each column represents a data point, and each cell corresponding to an intersecting row in the column corresponds to an attribute of that data point. The user can identify cells to be filled with predicted values. The system generates, for each column that has an identified cell, a respective model input that includes the values in the column other than the one in the row with identified cells. The system provides the model inputs to the trained machine learning model to generate predicted values for the identified cells.

In some implementations, the system can generate a respective predicted value for each of the identified cells on the user device, i.e., by performing inference using the trained machine learning model, on the user device.

In some implementations, the system can generate a respective predicted value for each of the identified cells, i.e., by performing inference using the trained machine learning model, on another computer, such as a remote server. For example, the system can transmit data representing the values in the cells of the interactive spreadsheet to a remote server, train a machine learning model on the values in the cells of the interactive spreadsheet to predict respective values for the one or more identified cells, generate a respective predicted value for each of the identified cells using the trained machine learning model, and receive data representing the respective predicted values from the remote server. The system can also train a machine learning model on the values in the cells of the interactive spreadsheet to predict respective values for the one or more identified cells on the user device, transmit data representing the values in the cells of the interactive spreadsheet and data representing the trained machine learning model to a remote server, generate a respective predicted value on the remote server for each of the identified cells using the trained machine learning model, and receive data representing the respective predicted values from the remote server.

The system displays the respective predicted values on the user device (step 250). The respective predicted values can be displayed on the interactive spreadsheet without transitioning to an intermediate display. The respective predicted values can be displayed directly on the interactive spreadsheet. The spreadsheet program does not need to transition the content of the display of the user device away from the interactive spreadsheet. For example, the spreadsheet program does not need to transition away from the interactive spreadsheet to displays with information such as a status of the prediction, displays that receive user inputs, or a second or different interactive spreadsheet. In some implementations, each respective predicted value can be displayed in a respective previously empty cell on the interactive spreadsheet. In some implementations, each respective predicted value can be displayed in the corresponding identified cell on the spreadsheet.

Generally, training the machine learning model (step 230), generating a respective predicted value for each of the identified cells using the trained machine learning model (step 240), and displaying the respective predicted values (step 250) are performed without receiving any additional user inputs after the user submits the input identifying the one or more cells to be filled in with respective predicted values. For example, the system does not require the user to choose training data, what model to train, or where to output the predicted values.

In some implementations, training the machine learning model (step 230), generating a respective predicted value for each of the identified cells using the trained machine learning model (step 240), and displaying the respective predicted values (step 250) are performed on the user device.

In some implementations where a machine learning model has already been trained, the system can receive an input with one or more additional values in cells in the interactive spreadsheet. The system can receive an input from a user or from an application or program that is integrated with the interactive spreadsheet. For example, the interactive spreadsheet can be integrated with a survey application or program that populates the interactive spreadsheet with survey responses. As another example, the interactive spreadsheet can be integrated with a data collecting tool such as a sensor or a data scraping tool that populates the interactive spreadsheet with new data.

The system can determine which cells corresponding to the one or more additional values the trained machine learning model is trained to predict. The system can generate a respective predicted value for each cell corresponding to the one or more additional values the trained machine learning model is trained to predict using the trained machine learning model. The system can display the respective predicted values on the user device.

For example, in an interactive spreadsheet where a machine learning model has already been trained and that is organized by column, an input with one or more additional values in cells can be a new row of values. The input can be a new survey response from a survey application or program that is integrated with the interactive spreadsheet. If the trained machine learning model is trained to predict values in column “H,” the system can identify which cell in the new row of values corresponds to column “H.” The system can generate a predicted value in the new row for the cell corresponding to column “H” using the trained machine learning model. The system can display the predicted value in column “H,” for example, in the new row on the interactive spreadsheet.

In some implementations where a machine learning model has already been trained, the system can receive an input from the user that identifies a trained machine learning model to be used in another interactive spreadsheet or shared with another user. For example, in an interactive spreadsheet where a machine learning model has already been trained, the user may want to save the trained machine learning model for later use in the interactive spreadsheet, for use in a different interactive spreadsheet, or for use by another user.

In some implementations, the system can receive an input from a user that identifies predicted values to analyze. The system can generate plots of the predicted values, for example, and display the plots on the user device.

The system can save data representing the trained machine learning model to a remote server or the user device. The system can display the location of the saved data representing the machine learning model. For example, the system can provide a link or a path to the saved data representing the machine learning model on the remote server or the user device. For example, data representing the trained machine learning model can include a file with an architecture and parameters for the trained machine learning model. Data representing the trained machine learning model can also include a serialization of the trained machine learning model.

In some implementations, the system can receive an input from the user that identifies cells in the interactive spreadsheet to be used as training data to train a machine learning model. In these implementations, the system can receive an input from the user that identifies cells in the interactive spreadsheet to be used as the target outputs of the training data. The system can divide the values in the identified cells into training, testing, and/or validation data. The system can use the training, testing, and/or validation data to train a machine learning model.

In some implementations where a machine learning model has already been trained, the system can receive an input from the user that identifies a trained machine learning model to be evaluated. The system can perform an evaluation of the trained machine learning model and display performance metrics from the evaluation on the user device. For example, the system can perform and display the resulting performance metrics from evaluation methods such as accuracy, receiver operating characteristic (ROC) curve, area under the ROC curve (AUC), confusion tables, log loss, or RMSE.

In some implementations where a machine learning model has already been trained, the system can receive an input from the user that identifies a trained machine learning model to be analyzed. The system can perform calculations of relative importance of input features on predicted outputs of the trained machine learning model and display results from the calculations on the user device. For example, the system can perform and display the results from calculations such as variable importance, prediction explanation, or a partial dependence plot.

As another example, the system can display information about the trained machine learning model, such as information about the input features for the trained machine learning model. The system can also display information about the quality of the trained machine learning model, such as evaluation metrics such as accuracy, computed during training of the trained machine learning model. As another example, the system can compute and display statistics about the training dataset.

As another example, the system can generate a representation of the trained machine learning model. For example, if the trained machine learning model is a decision tree, the system can generate a visualization of the decision tree and display the visualization of the decision tree.

In some implementations where a machine learning model has already been trained on values in a first interactive spreadsheet, the system can receive an input from the user that identifies a trained machine learning model to be used for prediction. For example, the system can use the trained machine learning model to generate predictions for different or additional values in the first interactive spreadsheet, or use the trained machine learning model to generate predictions for values in a second, different interactive spreadsheet.

The system can determine which cells in the interactive spreadsheet the trained machine learning model is trained to predict. For example, if the interactive spreadsheet is a second, different interactive spreadsheet, the system can determine if the second interactive spreadsheet is organized in the same way as the first interactive spreadsheet, e.g., by the same rows or columns. For example, if the trained machine learning model was trained to predict column “H” in a first interactive spreadsheet and the second interactive spreadsheet has columns arranged in the same way as the first interactive spreadsheet, the system can determine that the trained machine learning model is trained to predict column “H” in the second interactive spreadsheet.

As another example, the system can determine which cells in the second interactive spreadsheet the trained machine learning model is trained to predict by matching the header names of the rows or columns. For example, if the trained machine learning model was trained to predict the column with the header name “species” in the first interactive spreadsheet, the system can determine that the trained machine learning model is trained to predict the column with the header name “species” in the second interactive spreadsheet.

As another example, the trained machine learning model may have been trained on columns with the header names “bill_length_mm,” “bill_depth_mm,” and “flipper_length_mm” to make a prediction for a column with the header name “species.” The system can determine that the second interactive spreadsheet includes columns with matching header names “bill_length_mm,” “bill_depth_mm,” and “flipper_length_mm.” The system can thus determine that the trained machine learning model can be used to generate predictions for a column with the header name “species” using the columns with matching header names “bill_length_mm,” “bill_depth_mm,” and “flipper_length_mm.” In some examples, the second interactive spreadsheet may include the matching columns in a different order than in the first interactive spreadsheet. In some examples, the second interactive spreadsheet may have additional columns with header names that were not present in the first interactive spreadsheet, or that were not used as training data for the trained machine learning model.

The system can generate a predicted value for each cell in the spreadsheet the trained machine learning model is trained to predict using the trained machine learning model. The system can display the predicted values on the user device.

In some implementations, the system can receive an input from the user that identifies a machine learning model to be refined. The system can transmit data representing the values in the cells of the interactive spreadsheet and data representing the machine learning model to a remote server. The system can generate a refined machine learning model based on the machine learning model. For example, for a machine learning model with parameters, the system can perform autotuning on the parameters. The system can also train multiple types of machine learning models on the values in the cells of the interactive spreadsheet and select the machine learning model with the highest performance, for example the highest accuracy, to be the refined machine learning model. The system can also perform other operations that are more resource-intensive. For example, if the machine learning model includes a decision forest model, the system can train the decision forest model with more trees. If the machine learning model includes a neural network, the system can train the neural network for a larger number of epochs. As another example, if the machine learning model includes a language model, the system can fine-tune the language model. In some implementations, the system can process the values in the cells of the interactive spreadsheet to generate features to provide to the machine learning model. For example, the system can use another machine learning model to embed values that are text to generate text features, or to embed values that are images to generate image features. The system can receive data representing the refined machine learning model from the remote server.

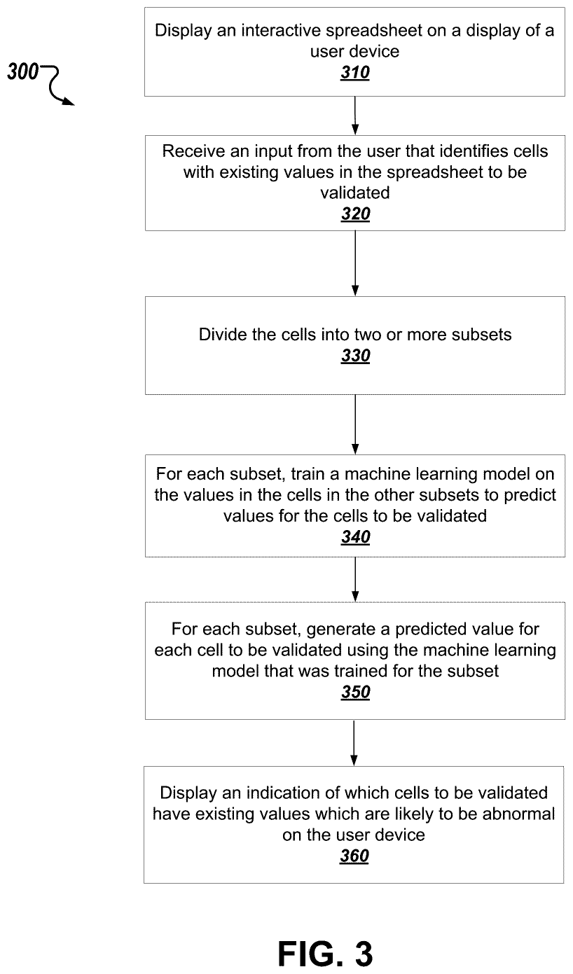

FIG. 3 is a flow diagram of an example process 300 for displaying predicted abnormal values on a user device. For example, an abnormal value can be a value that was altered or that was not inputted correctly into an interactive spreadsheet. The process 300 can be performed by any appropriate system, e.g., the system 100 described above with reference to FIG. 1.

The system displays an interactive spreadsheet on a display of a user device (step 310). As described above with reference to FIG. 2, the interactive spreadsheet displays values in cells arranged by row and column.

The system receives an input from the user that identifies cells with existing values in the spreadsheet to be validated (step 320).

The system divides the cells into two or more subsets (step 330), for example, using k-fold cross-validation to divide the cells into k subsets, where k is an integer greater than or equal to two. Each subset can have one or more data points with input features and corresponding target outputs to the cells to be validated.

For each subset, the system trains a machine learning model on the values in the cells in the other subsets to predict values for the cells to be validated (step 340). That is, for each subset, the system trains a machine learning model as described above with reference to FIGS. 1 and 2, but without including data points corresponding to the cells in the subset. For each subset, the system generates a predicted value for each cell to be validated using the machine learning model that was trained for the subset (step 350). That is, the system generates predicted values for each cell to be validated in the subset using a machine learning model that was not trained on any of the cells in the subset.

The system can display an indication of which cells to be validated have existing values which are likely to be abnormal on the user device (step 360). For example, an existing value that is likely to be abnormal can be an existing value that is not equal to the predicted value, or an existing value where a difference between the existing value and the predicted value is greater than a threshold. To display an indication of which cells to be validated have existing values which are likely to be abnormal, the system can, for example, highlight the cells that contain existing values that are likely to be abnormal. The system can also display the predicted values on the user device. For example, the system can display a dialog box with the predicted values. The system can also display the predicted values in cells next to or near the cells with existing values.

In some implementations, the system can also determine an accuracy for each machine learning model. For example, the system can determine a root-mean-square error (RMSE) for each machine learning model.

The system can determine scores for the cells to be validated based on a difference between each predicted value and the existing value for the cell, also referred to as a prediction residual, and the accuracy for the machine learning model that generated the predicted value. For example, if the machine learning model is a classifier, the score for a cell can be based on the difference between the highest probability assigned to any of the possible output values by the model and the probability assigned to the existing value by the model. For example, the score s can be calculated using the following equation:

s=max_{y}(P(label=y|model x))−P(label=existing value|model x)

where y is a possible output value or prediction that the machine learning model can output, existing value is the existing value in the cell, and model x is the machine learning model for the subset that the cell was divided into.

When the predicted value is the same as the existing value, the score will be zero. When the predicted value is different from the existing value, the score is related to the confidence of the machine learning model in its prediction. For example, the score will be higher if the predicted value is different from the existing value and the machine learning model has higher confidence in its prediction.

As another example, if the machine learning model is a regression model, the score can be related to a biased p-value if the prediction residual is from the same distribution as all other residuals. For example, the score can be computed based on the p-value of a statistical test setup that determines if the prediction residual for a cell differs significantly from other prediction residuals for other cells. For example, the score s can be calculated using the following equation:

$$s = 1 - 2 * ( 1 - Φ ( \vert \frac{predicted value - existing value}{r} \vert - b ) )$$

where Φ is the cumulative distribution function (CDF) of a standard normal distribution, r is the RMSE for the machine learning model, predicted value is the predicted value by the machine learning model for the cell, existing value is the existing value in the cell, and b is a parameter that can be defined. For example, b can be set so that there is a 5% chance that an existing value has a score s that is non-zero.

The system can display an indication of which cells to be validated have existing values which are likely to be abnormal based on the scores on the user device. For example, the system can highlight the cells with scores above a threshold in red. The system can also display the scores on the user device. For example, the system can display the scores in a dialog box. The system can also display the score for a cell with an existing value in a cell next to or near the cell with the predicted value.

FIG. 4A shows an example display of an interactive spreadsheet 106. The interactive spreadsheet 106 can be the interactive spreadsheet 106 of FIG. 1. The interactive spreadsheet displays values in cells arranged by row and column. For example in FIG. 4A, each row refers to a penguin, and each column contains a different attribute of the penguin such as bill length (“bill_length_mm”), bill depth (“bill_depth_mm”), and flipper length (“flipper_length_mm”).

The spreadsheet program that displays the interactive spreadsheet can include many options for user interaction with the interactive spreadsheet, including inputting values into cells. Values can be one of many data types, for example, numbers, text, dates, and times. While the spreadsheet program displays the interactive spreadsheet in a first portion 402 of a user interface in a display of a user device, the spreadsheet program can also display a second portion 403 of the user interface. The second portion 403 can include a first user interface element 404 that is displayed in response to a user input to a menu item of the interactive spreadsheet. For example, the first user interface element 404 in FIG. 4A includes menu options such as “Task,” “Models,” “About,” and elements for user input.

The first user interface element 404 can include a second user interface element 405 that allows a user to identify one or more cells, identified cells 406, in the interactive spreadsheet. For example, the second user interface element 405 can be a dropdown menu, an input field that takes in specific cells or ranges of cells, such as “H2” or “H2 to H28,” radio buttons, or a user interface element that allows a user to select or highlight the cells on the interactive spreadsheet.

In the example of FIG. 4A, the second user interface element 405 is a dropdown menu that identifies the column “species” as the one or more cells in the interactive spreadsheet. FIG. 4A also shows that the identified cells 406 are in the column labeled “species.”

The first user interface element 404 can also include a user interface control 408 that, when selected, causes the interactive spreadsheet to be updated with respective predicted values for each of the cells identified through the second user interface element 405. For example, the user interface control 408 can be a button or an input field. In response to receiving an input to the user interface control 408, the interactive spreadsheet can be updated to display the predicted values. The predicted values for each of the cells identified through the second user interface element 405 can be predicted by a trained machine learning model.

In the example of FIG. 4A, the user interface control 408 is a button labeled “Predict.” In response to receiving an input to the user interface control 408, the interactive spreadsheet can be updated to display the predicted values. For example, the example display of FIG. 4A can transition to the example display of FIG. 4B.

The first user interface element 404 can include a third user interface element 410 that allows a user to select a task out of a plurality of tasks to be performed in the interactive spreadsheet 106. Tasks can include, for example, predicting missing values (also referred to as filling with predicted values) or identifying abnormal values (also referred to as spotting abnormal values). Tasks can also include training a model, refining a model, using a model in another interactive spreadsheet or sharing a model with another user, evaluating a model, analyzing a model (also referred to as understanding a model), or making predictions with a model.

In some implementations, when the task selected by the user on the third user interface element 410 is identifying abnormal values, the second user interface element 405 is updated to allow the user to identify one or more cells in the interactive spreadsheet 106 to be validated. The first user interface element can include a user interface control such as user interface control 408, that, when selected, causes the interactive spreadsheet 106 to be updated with an indication of which cells have existing values which are likely to be abnormal for each of the one or more cells identified through the second user interface element 405. For example, the user interface control can be a button labeled “Spot abnormal values.”

In some implementations, when the task selected by the user on the third user interface element 410 is refining a trained machine learning model, the second user interface element 405 is updated to allow the user to identify one or more machine learning models to be refined. The first user interface element can include a user interface control such as user interface control 408, that, when selected, causes the interactive spreadsheet 106 to be updated with an indication of how the trained machine learning model was refined. For example, the user interface control can be a button labeled “Refine.”

In some implementations, when the task selected by the user on the third user interface element 410 is using a trained machine learning model in another interactive spreadsheet or sharing a trained machine learning model with another user, the second user interface element 405 is updated to allow the user to identify one or more machine learning models to be used or shared. The first user interface element can include a user interface control such as user interface control 408, that, when selected, causes the interactive spreadsheet 106 to be updated with a location of saved data representing the trained machine learning model. For example, the user interface control can be a button labeled “Save” or “Share.”

In some implementations, when the task selected by the user on the third user interface element 410 is evaluating a trained machine learning model, the second user interface element 405 is updated to allow the user to identify one or more machine learning models to be evaluated. The first user interface element can include a user interface control such as user interface control 408, that, when selected, causes the interactive spreadsheet 106 to be updated with performance metrics from an evaluation of the trained machine learning model. For example, the user interface control can be a button labeled “Evaluate.”

In some implementations, when the task selected by the user on the third user interface element 410 is analyzing a trained machine learning model, the second user interface element 405 is updated to allow the user to identify one or more machine learning models to be analyzed. The first user interface element can include a user interface control such as user interface control 408, that, when selected, causes the interactive spreadsheet 106 to be updated with results from calculations of relative importance of input features on predicted outputs of the trained machine learning model. For example, the user interface control can be a button labeled “Analyze” or “Understand.”

In some implementations, when the task selected by the user on the third user interface element 410 is using a trained machine learning model for prediction, the second user interface element 405 is updated to allow the user to identify one or more machine learning models to be used for prediction. The first user interface element can include a user interface control such as user interface control 408, that, when selected, causes the interactive spreadsheet 106 to be updated with respective predicted values for each of the one or more cells in the interactive spreadsheet 106 the trained machine learning model is trained to predict. For example, the user interface control can be a button labeled “Predict.”

FIG. 4B shows an example display of predicted values on an interactive spreadsheet 106. After a trained machine learning model generates a predicted value for each of the identified cells in identified cells 406, the interactive spreadsheet 106 can be updated to display the predicted values 412. For example, FIG. 4B shows that the predicted values 412, predicted species, are displayed on the interactive spreadsheet 106 in a new column “pred:species.”

In some implementations, the predicted values 412 can be displayed in the original identified cells themselves. For example, the predicted values 412 that are displayed in FIG. 4B in column “I” can be displayed in the identified cells 406 in column “H.” In some implementations, the predicted values 412 can be displayed in a dialog box of the interactive spreadsheet.

In some implementations, predicted confidence values that specify how confident the machine learning model is in its predictions can also be displayed, for example, in a new column on the spreadsheet as shown in the column “pred:Conf.species” in FIG. 4B, or in a dialog box of the interactive spreadsheet. For example, the model can be a classifier model that outputs a prediction for a class that has the highest probability. In some examples, the system can obtain the probability for the predicted class and use the probability as the confidence value. As an example, if the model is a Random Forest model, the system can obtain the probability for the predicted class using leaf distribution or leaf voting.

In some implementations, an overall accuracy of the model can also be displayed, for example, in a dialog box of the interactive spreadsheet. For example, the system can evaluate the model to determine an accuracy of the model.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions.

Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and

CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
displaying an interactive spreadsheet on a display of a user device, wherein the interactive spreadsheet displays values in cells arranged by row and column;
receiving an input from a user that identifies one or more cells to be filled in with respective predicted values;
in response to receiving the input:
training a machine learning model on the values in the cells of the interactive spreadsheet to predict respective values for the one or more identified cells;
generating a respective predicted value for each of the identified cells using the trained machine learning model; and
displaying the respective predicted values on the user device.

2. The method of claim 1, wherein each respective predicted value is displayed in a respective previously empty cell on the interactive spreadsheet.

3. The method of claim 1, wherein the respective predicted values are displayed on the interactive spreadsheet without transitioning to an intermediate display.

4. The method of claim 1, wherein training the machine learning model, generating a respective predicted value for each of the identified cells using the trained machine learning model, and displaying the respective predicted values are performed on the user device.

5. The method of claim 1, wherein training the machine learning model, generating a respective predicted value for each of the identified cells using the trained machine learning model, and displaying the respective predicted values are performed without receiving any additional user inputs.

6. The method of claim 1, wherein training the machine learning model comprises training the machine learning model on the user device without transferring the values in the interactive spreadsheet to other computers.

7. The method of claim 1, wherein training the machine learning model comprises determining which cells in the interactive spreadsheet are provided as input features and target outputs for the training of the machine learning model based on the identified cells.

8. The method of claim 1, wherein training the machine learning model comprises preprocessing the values in the cells using metadata for the corresponding cells.

9. The method of claim 1, further comprising:
receiving an input from the user that identifies a machine learning model to be refined; in response to receiving the input:
transmitting data representing the values in the cells of the interactive spreadsheet and data representing the machine learning model to a remote server;
generating a refined machine learning model based on the machine learning model; and
receiving data representing the refined machine learning model from the remote server.

10. The method of claim 1, further comprising:
receiving an input from the user that identifies one or more cells to be filled in with respective predicted values;
in response to receiving the input:
transmitting data representing the values in the cells of the interactive spreadsheet to a remote server;
training a machine learning model on the values in the cells of the interactive spreadsheet to predict respective values for the one or more identified cells;
receiving data representing the trained machine learning model from the remote server;
generating a respective predicted value for each of the identified cells using the trained machine learning model; and
displaying the respective predicted values on the user device.

11. The method of claim 1, further comprising:
receiving an input from the user that identifies one or more cells to be filled in with respective predicted values;
in response to receiving the input:
transmitting data representing the values in the cells of the interactive spreadsheet to a remote server;
training a machine learning model on the values in the cells of the interactive spreadsheet to predict respective values for the one or more identified cells;
generating a respective predicted value for each of the identified cells using the trained machine learning model;
receiving data representing the respective predicted values from the remote server; and
displaying the respective predicted values on the user device.

12. The method of claim 1, further comprising:
receiving an input from the user that identifies one or more cells to be filled in with respective predicted values;
in response to receiving the input:
training a machine learning model on the values in the cells of the interactive spreadsheet to predict respective values for the one or more identified cells;
transmitting data representing the values in the cells of the interactive spreadsheet and data representing the trained machine learning model to a remote server;
generating a respective predicted value on the remote server for each of the identified cells using the trained machine learning model;
receiving data representing the respective predicted values from the remote server; and
displaying the respective predicted values on the user device.

13. The method of claim 1, further comprising:
receiving an input with one or more additional values in cells in the interactive spreadsheet;
in response to receiving the input:
determining which cells corresponding to the one or more additional values the trained machine learning model is trained to predict;
generating a respective predicted value for each cell corresponding to the one or more additional values the trained machine learning model is trained to predict using the trained machine learning model; and
displaying the respective predicted values on the user device.

14. The method of claim 1, further comprising:
receiving an input from the user that identifies a trained machine learning model to be used in another interactive spreadsheet or shared with another user;
in response to receiving the input, saving data representing the trained machine learning model to a remote server or the user device; and
displaying the location of the saved data representing the trained machine learning model.

15. The method of claim 1, further comprising:
receiving an input from the user that identifies a trained machine learning model to be evaluated; and
in response to receiving the input, performing an evaluation of the trained machine learning model and displaying performance metrics from the evaluation on the user device.

16. The method of claim 1, further comprising:
receiving an input from the user that identifies a trained machine learning model to be analyzed; and
in response to receiving the input, performing calculations of relative importance of input features on predicted outputs of the trained machine learning model and displaying results from the calculations on the user device.

17. The method of claim 1, further comprising:
receiving an input from the user that identifies a trained machine learning model to be used for prediction;
in response to receiving the input:
determining which cells in the interactive spreadsheet the trained machine learning model is trained to predict;
generating a respective predicted value for each cell in the spreadsheet the trained machine learning model is trained to predict using the trained machine learning model; and
displaying the respective predicted values on the user device.

18. A method comprising:
displaying an interactive spreadsheet on a display of a user device, wherein the interactive spreadsheet displays values in cells arranged by row and column;
receiving an input from the user that identifies cells with existing values in the spreadsheet to be validated;
in response to the input:
dividing the cells into two or more subsets comprising input features and corresponding target outputs to the cells to be validated;
for each subset, training a machine learning model on the values in the cells in the other subsets to predict values for the cells to be validated;
for each subset, generating a predicted value for each cell to be validated using the machine learning model that was trained for the subset; and
displaying an indication of which cells to be validated have existing values which are likely to be abnormal on the user device.

19. The method of claim 18, further comprising:
determining an accuracy for each machine learning model;
determining scores for the cells to be validated based on a difference between each predicted value and the existing value for the cell and the accuracy for the machine learning model that generated the predicted value; and
displaying an indication of which cells to be validated have existing values which are likely to be abnormal based on the scores on the user device.

20. A system comprising one or more computers and one or more storage devices storing instructions that when executed by the one or more computers cause the one or more computers to perform operations comprising:
displaying an interactive spreadsheet on a display of a user device, wherein the interactive spreadsheet displays values in cells arranged by row and column;
receiving an input from a user that identifies one or more cells to be filled in with respective predicted values;
in response to receiving the input:
training a machine learning model on the values in the cells of the interactive spreadsheet to predict respective values for the one or more identified cells;
generating a respective predicted value for each of the identified cells using the trained machine learning model; and
displaying the respective predicted values on the user device.

21. One or more non-transitory computer-readable storage media storing instructions that when executed by one or more computers cause the one or more computers to perform operations comprising:
displaying an interactive spreadsheet on a display of a user device, wherein the interactive spreadsheet displays values in cells arranged by row and column;
receiving an input from a user that identifies one or more cells to be filled in with respective predicted values;
in response to receiving the input:
training a machine learning model on the values in the cells of the interactive spreadsheet to predict respective values for the one or more identified cells;
generating a respective predicted value for each of the identified cells using the trained machine learning model; and
displaying the respective predicted values on the user device.
